(19) United States
(12) Patent Application Publication
(10) Pub. No.: US 2015/0046182 A1
(43) Pub. Date: Feb. 12, 2015

(54) METHODS AND AUTOMATED SYSTEMS THAT ASSIGN MEDICAL CODES TO ELECTRONIC MEDICAL RECORDS

(71) Applicant: Atigeo LLC, Bellevue, WA (US)

(72) Inventors: Rodney Kinney, Bellevue, WA (US); Michael Sandoval, Bellevue, WA (US); David Talby, Bellevue, WA (US); Gunjan Gupta, Bellevue, WA (US); Manjula Iyer, Bellevue, WA (US)

(73) Assignee: Atigeo LLC, Bellevue, WA (US)

(21) Appl. No.: 13/960,054

(22) Filed: Aug. 6, 2013

(51) Int. Cl. G06F 19/00

(52) U.S. Cl. CPC G06F 19/328
USPC 705/3

(57) ABSTRACT

The current document is directed to methods and automated systems that assign individual medical codes selected from one or more medical codebooks to electronic medical records. In certain implementations, the currently disclosed automated systems generate multiple streams of medical terms or medical terms and phrases from an electronic medical record as well as multiple streams of medical terms or medical terms and phrases from individual medical codes contained within a medical codebook and then use stream-comparison functionality to select those individual medical codes of the medical codebook most likely to be relevant and related to the information encoded within the electronic medical record. In addition, in a disclosed implementation, the automated medical-coding system includes comprehensive training and feedback components that allow the automated medical-coding system to be trained and to continuously improve, over time, the accuracy, precision, and reliability of the assignment of medical codes to electronic medical records.

### TECHNICAL FIELD

The current document is related to electronic medical records and data processing and, in particular, to methods and systems that analyze electronic medical records in order to assign medical codes to the analyzed electronic medical records.

### BACKGROUND

Over the past 20 years, the health-care industry has progressively transformed record keeping and data processing to allow for an ever-greater degree of automation, using modern economical computer systems with large data-storage capacities and large computational bandwidths. It is expected that patient records and information will soon be entirely encoded and maintained in electronic medical records. Electronic medical records have many advantages over paper-document-based files and older data-storage media, including cost efficiency, standardization, rapid and straightforward transfer of electronic medical records among health-care providers, health-care-providing organizations, and insurance companies, and efficient processing and analysis of electronic medical records using powerful application programs running on large, distributed computer systems, including cloud-computing systems. Nonetheless, the information stored in electronic medical records is often initially generated manually by a physician or other health-care provider through dictation, electronic data-entry applications, and by other means.

During processing of an electronic medical record (“EMR”), particularly for generation of a billing statement by a health-care provider for submission to an insurance company, individual medical codes that are related to the information contained within the electronic medical record (“EMR”), such as individual medical codes selected from one or more of the various revisions of the International Classification of Diseases medical codebook, including the ICD9 and ICD10 medical codebooks, the Current Procedural Terminology (“CPT”) medical codebook, the Systematized Nomenclature of Medicine (“SNOMED”) medical codebook, and other medical codebooks, need to be identified and associated with the EMR. The related individual medical codes, once identified for a particular EMR, are incorporated within the EMR or associated with the electronic medical record. The related individual medical codes may serve as easily processed summaries of the information content of the electronic medical record that can be used by automated systems to facilitate generation and processing of billing statements and may be used for a variety of additional types of analyses, including various types of research, quality-control, auditing, and other types of analyses carried out by, or on behalf of, various types of health-care providers and health-care-providing organizations.

Traditionally, the identification and assignment of medical codes to electronic medical records has been a largely manual or computer-assisted manual task carried out by trained analysts. However, with the emergence of modern economical computer systems with large data-storage capacities and large computational bandwidths, efforts have been undertaken to at least partially automate the medical-code-assignment process. Unfortunately, to date, these efforts have fallen short of desired accuracy, precision, and reliability. Researchers and developers, vendors and manufacturers of automated systems, and, ultimately, health-care providers and health-care-providing organizations continue to seek an automated medical-coding system that provides adequate accuracy, precision, and reliability in the automated assignment of medical codes to electronic medical records.

### SUMMARY

The current document is directed to methods and automated systems that assign individual medical codes selected from one or more medical codebooks to electronic medical records. In certain implementations, the currently disclosed automated systems generate multiple streams of medical tennis or medical terms and phrases from an electronic medical record as well as multiple streams of medical terms or medical terms and phrases from individual medical codes contained within a medical codebook and then use stream-comparison functionality to select those individual medical codes of the medical codebook most likely to be relevant and related to the information encoded within the electronic medical record. In addition, in a disclosed implementation, the automated medical-coding system includes comprehensive training and feedback components that allow the automated medical-coding system to be trained and to continuously improve, over time, the accuracy, precision, and reliability of the assignment of medical codes to electronic medical records.

### BRIEF DESCRIPTION OF THE DRAWINGS

FIG. 1 provides a general architectural diagram for various types of computers, including computer systems that execute stored computer instructions that implement an automated medical-coding system.

FIG. 2 illustrates an automated process that assigns medical codes to electronic medical records.

FIG. 3 illustrates a stream-comparison operation used in implementations of the currently disclosed methods and systems to evaluate individual medical codes within a medical codebook with respect to a particular EMR.

FIG. 4 illustrates an additional granularity of learned weights within certain implementations of the disclosed methods and systems.

FIG. 5 illustrates use of the results of the stream-comparison operation, discussed above with reference to FIGS. 3 and 4, to select a set of medical codes with high probability of being related to the information contained within an EMR.

FIG. 6 illustrates training and feedback aspects of the disclosed methods and systems.

FIG. 7 shows an example of an electronic medical record.

FIGS. 8-10 provide high-level control-flow diagrams that illustrate one implementation of an automated system that assigns medical codes to EMRs.

FIGS. 11A-J illustrate generation of a number of example term or term-and-phrase streams from the example EMR shown in FIG. 7.

FIG. 12 illustrates organization of a typical medical codebook.

FIG. 13 illustrates one type of hierarchical organization within a medical codebook.

FIGS. 14A-B show small portions of an actual medical codebook.

FIGS. 15A-D provide control-flow diagrams that complete the description of one implementation of an automated medical-code assignment system that includes references to FIGS. 8-10.

FIG. 16 illustrates aspects of the training compare operation, discussed above with reference to FIG. 6, in which medical codes associated with an EMR by an automated system are compared to the medical codes associated with the same EMR by human analysts or by another method.

FIG. 17 provides a control-flow diagram for the routine “training,” called in step 806 of FIG. 8.

### DETAILED DESCRIPTION

The current document is directed to automated systems, and methods incorporated within the automated systems, that assign individual medical codes of one or more medical codebooks to electronic medical records. These automated medical-coding systems generate multiple streams of terms or multiple streams of terms and phrases from electronic medical records (“EMRs”) as well as from individual medical codes selected from one or more medical codebooks and compare the contents of the multiple streams in order to assign a score to individual medical codes with respect to a particular EMR. Those individual medical codes with computed scores most reflective of relatedness to the particular EMR are then selected for annotation of the EMR.

It should be noted, at the onset, that the currently disclosed methods carry out real-world operations on physical systems and the currently disclosed systems are real-world physical systems. Implementations of the currently disclosed subject matter may, in part, include computer instructions that are stored on physical data-storage media and that are executed by one or more processors in order to analyze EMRs and to assign individual medical codes of one or more medical codebooks to the EMRs. These stored computer instructions are neither abstract nor fairly characterized as “software only” or “merely software.” They are control components of the systems to which the current document is directed that are no less physical than processors, sensors, and other physical devices.

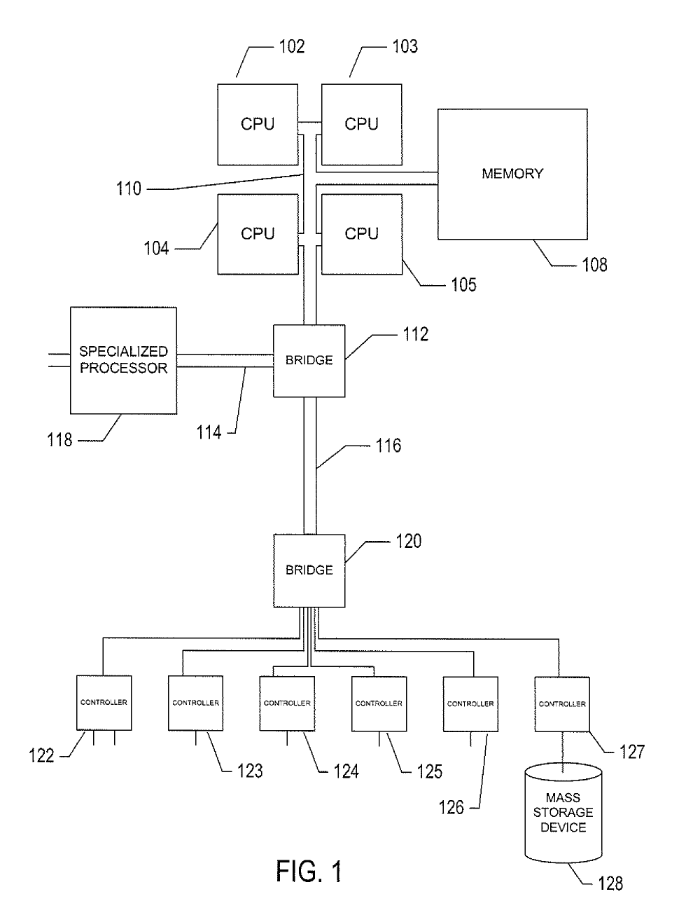

FIG. 1 provides a general architectural diagram for various types of computers, including computer systems that execute stored computer instructions that implement an automated medical-coding system. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources.

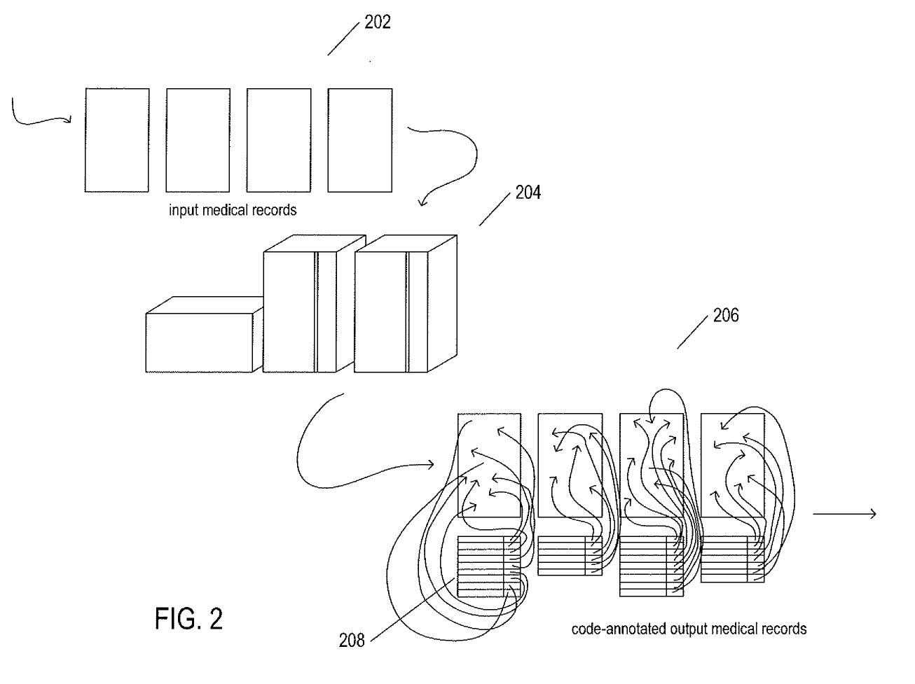

FIG. 2 illustrates an automated process that assigns medical codes to electronic medical records. As shown in FIG. 2, a sequence or set of electronic medical records (“EMRs”) 202 is input to an automated system 204 that assigns codes to the input EMRs. The system analyzes the information content of each EMR in the input set, identifies those individual medical codes within one or more medical codebooks with highest probability of being related to the information contained within each EMR, and electronically annotates each EMR with the identified individual medical codes, outputting the code-annotated EMRs 206. The code-annotated EMRs 206 may be stored temporarily or for a long period of time within the automated medical-coding system 204 and/or transmitted by the automated medical-coding system 204 to remote computer systems, including remote computer systems maintained by insurance companies and health-care-providing organizations. In FIG. 2, the code annotations are represented as tables, such as table 208, each entry of which includes a medical code as well as a reference or pointer to a word, phrase, sentence, or paragraph within the EMR to which the medical code is related. In practice, each entry would generally contain at least one, and often, multiple references to terms and phrases within the EMR. There are, however, many different possible ways in which an EMR can be electronically annotated. For example, related codes can be inserted directly into the text of an EMR. Alternatively, the related codes may be stored in a second electronic document associated with the EMR or may be alternatively stored within indexed files, one or more database systems, or other types of electronic data-storage facilities.

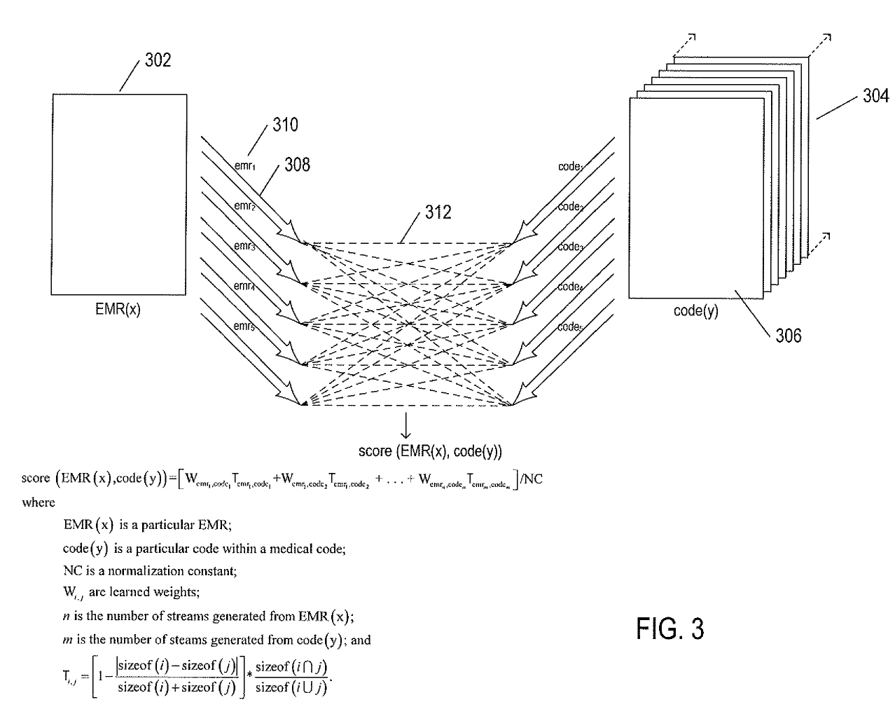

FIG. 3 illustrates a stream-comparison operation used in implementations of the currently disclosed methods and systems to evaluate individual medical codes within a medical codebook with respect to a particular EMR. The stream-valuation method produces a real-valued score in the range [0,1], in this implementation. The larger the magnitude of the score, the greater the probability that the individual medical code is related to, or applicable to, the particular EMR with respect to which the individual medical code is evaluated in the stream-comparison operation. Of course, an opposite convention can be used, in which lower-magnitude scores indicate greater relatedness. Other conventions are also possible. In FIG. 3, the comparison of an individual medical code from a medical codebook to the information contained within a specific EMR is illustrated. The specific EMR 302 is described by the notation “EMR(x).” In general, an EMR is a text file or document that describes a patient, a patient visit, a procedure, a patient history, pharmaceuticals administered to the patient, and other such information. An example EMR is discussed below.

The medical codebook 304 is a generally voluminous compendium of individual medical codes, including numeric or alphanumeric codes along with textural descriptions of the codes. Medical codebooks are generally stored electronically within any of various types of electronic data-storage devices or systems. In many cases, medical codebooks are hierarchically organized into chapters and lower-level sections and subsections, as discussed further below. An automated system can be controlled to extract individual medical codes and associated descriptions from a medical codebook. In FIG. 3, the automated system has extracted a particular code 306, code(y), from the medical codebook 304.

The automated system generates multiple streams of terms or multiple streams of terms and phrases from both the particular EMR, EMR(x), and the particular code, code(y). In FIG. 3, each stream of terms or terms and phrases is represented by an arrow, such as stream 308 produced from the contents of EMR(x) 302. In FIG. 3, each stream is labeled with a stream identifier, such as the identifier “emr₁” 310 that identifies stream 308. The generation of the streams from the EMR and individual medical code are discussed further, below. In general, each stream comprises a sequence of terms or terms and phrases extracted from either the EMR or individual medical code or from additional sources of terms or terms and phrases, including medical dictionaries, portions of the medical codebook other than the description of the individual extracted code, and other such sources.

In certain implementations, the streams are composed entirely of terms. In other implementations, the streams may include both terms and short phrases. In the latter case, the term and phrases may be separated by delimiter symbols, such as commas.

As indicated in FIG. 3 by dashed lines, such as dashed line 312, the comparison operation that generates a score for a particular EMR/individual-code pair involves comparison of each possible pair of streams that include a stream generated from the EMR and a stream generated from the individual medical code. In other words, the stream-comparison operation involves a cross-product-like comparison of all possible stream pairs that include a stream generated from the EMR and a stream generated from the individual medical code.

As indicated in FIG. 3, in one implementation, the score generated by the stream-comparison operation for a particular individual medical code with respect to a particular EMR, score(EMR(x),code(y)), is computed as a sum of terms divided by a normalization constant:

score(EMR(x),code(y))=[Wₑₘᵣ_{₁}_{,code}_{₁}Tₑₘᵣ_{₁}_{,code}_{₁}+Wₑₘᵣ_{₁}_{,code}_{₂}Tₑₘᵣ_{₁}_{,code}_{₂}+ . . . +Wₑₘᵣ_{ₙ}_{,code}_{ₙ}Tₑₘᵣ_{ₙ}_{,code}_{ₙ}]/NC

where

EMR (x) is a particular EMR;

code (y) is a particular code within a medical code;

NC is a normalization constant;

W_{i,j} are learned weights;

n is the number of streams generated from EMR (x);

m is the number of steams generated from code(y); and

$${T}_{i , j} = [ 1 - \frac{\vert sizeof ( i ) - sizeof ( j ) \vert}{sizeof ( i ) + sizeof ( j )} ] * \frac{sizeof ( i ⋂ j )}{sizeof ( i ⋃ j )} .$$

Thus, each term in the sum of terms is the product of a weight for a particular stream pair and a term T_{i,j} that is computed as a product of two quantities. The first quantity has the value 1 when the size of the two streams is equal and decreases with increasing disparity in the sizes of the two streams and the second term is the ratio of the number of terms or terms and phrases common to both streams divided by the total number of different terms or terms and phrases in both streams, represented in the above equation using set intersection ∩ and set union ∪. The normalization constant NC may be the total number of terms in the sum of terms used to compute the score, but may also be a different normalization constant, in alternative implementations. The weights W_{i,j} are learned by the automated system from training data comprising EMRs with code annotations produced by either human analysts or by some other means other than by the automated system that is being trained. Training is discussed in greater detail below.

Thus, the score is computed as a weighted sum of terms, each term reflective of the similarity between the terms or terms and phrases within each possible pairwise combination of streams from the particular EMR and particular code being compared with respect to the particular EMR. Over time, the automated system adjusts the values of the different weights so that those pairs of streams most reflective of the relevance of a particular code to a particular EMR provide greater input to the final score generated in the stream comparison operation. The above expression is but one possible approach to generating a stream-comparison score. In alternative approaches, the score may have both negative and positive values, such as being in the range [−1,1], with the weights also having both positive and negative values. The terms may be alternatively computed, in alternative implementations. In general, the score reflects the likelihood that a particular code is related to a particular EMR. The magnitudes of the individual terms in the expression for the score may additionally provide indications of the particular terms or terms and phrases within the EMR specifically related to a particular code, allowing the automated system to map related medical codes from a medical codebook back to particular terms or terms and phrases within an EMR to which they are related, thus providing the references discussed above with reference to FIG. 2.

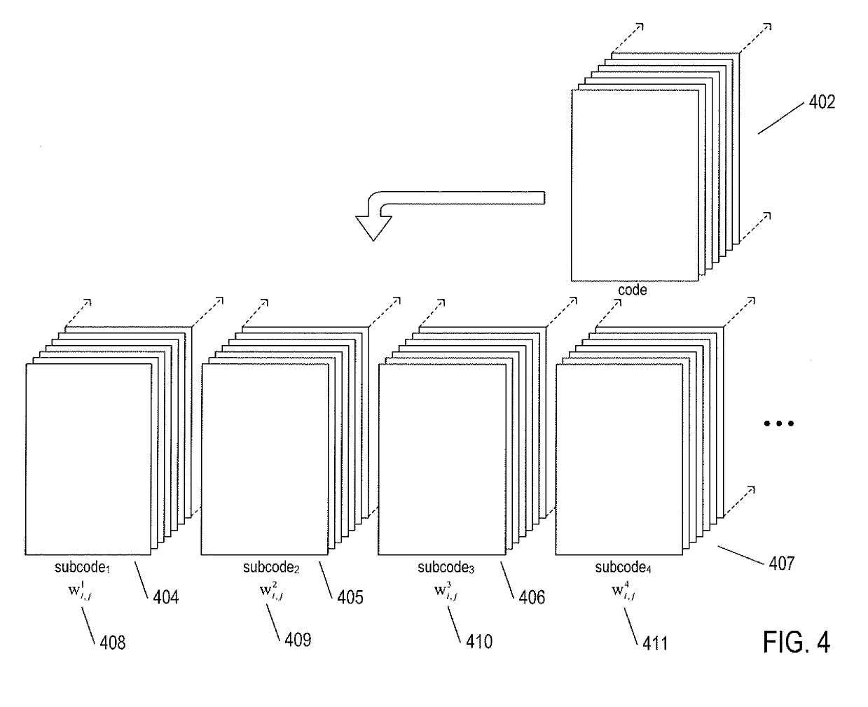

FIG. 4 illustrates an additional granularity of learned weights within certain implementations of the disclosed methods and systems. As shown in FIG. 4, a medical codebook 402 may be subdivided into a set of two or more subcodes 404-407. Each of the subcodes may then be associated with a different set of weights 408-411. During the stream-comparison operation discussed above with reference to FIG. 3, the weights associated with a subcode from which a currently considered code is extracted and evaluated with respect to a particular EMR are used in the scoring operation. Thus, the granularity of learning may descend to the level of an arbitrary number of subcodes to improve scoring.

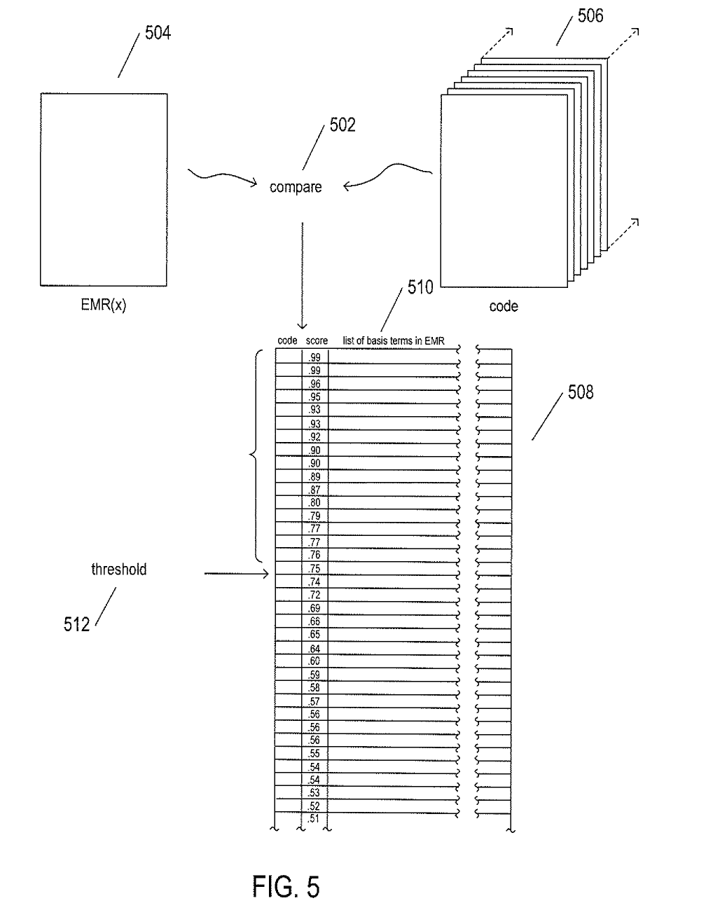

FIG. 5 illustrates use of the results of the stream-comparison operation, discussed above with reference to FIGS. 3 and 4, to select a set of medical codes with high probability of being related to the information contained within an EMR. As shown in FIG. 5, the stream-comparison operation 502 on the multiple term or term-and-phrase streams generated from a particular EMR 504 and each of multiple codes selected from a medical codebook 506 generate a set of codes associated with scores. These codes with associated scores are sorted, in descending order, by the magnitude of the scores to generate a sorted list 508 of code/score pairs. This assumes the convention in which scores with greater magnitudes In certain implementations, the code/score pairs may be supplemented with a list of the basis terms or terms and phrases in the EMR, shown in column 510 in FIG. 5, that contributed significantly to the magnitude of the score for the code. This list of basis terms or terms and phrases may subsequently be used to generate one or more references that relate a particular code back to one or more terms or phrases within the EMR to which the code is particularly related. Next, a threshold 512 is applied to select the codes with the scores of greatest associated magnitudes as the codes to be associated with, or applied to, the EMR 504. In an example shown in FIG. 5, the codes with associated scores having magnitudes greater than or equal to 0.75 are selected as having sufficient probability of relatedness to information within the EMR to be associated with the EMR. As discussed above with reference to FIG. 4, the stream-comparison operation may be employed to compare a given EMR with the codes of a medical codebook or with the codes in a particular subset of the medical codebook.

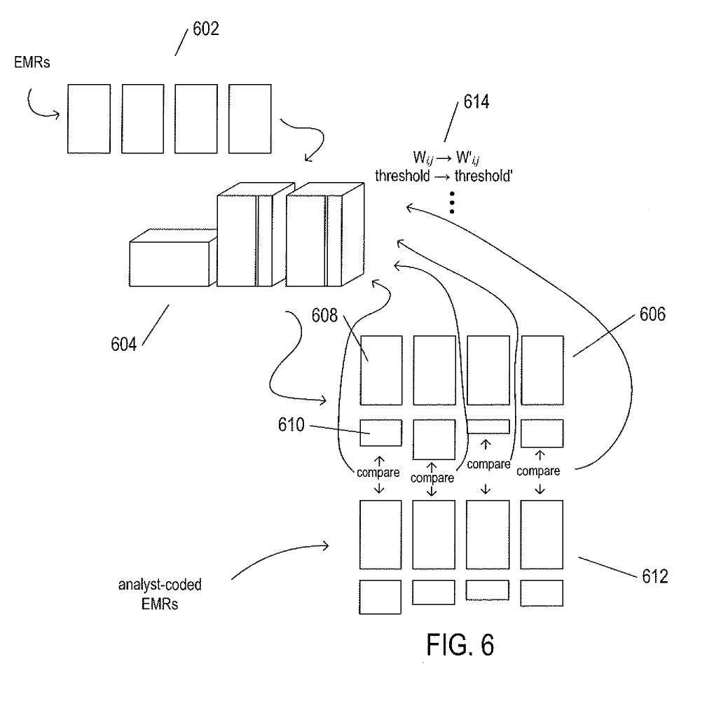

FIG. 6 illustrates training and feedback aspects of the disclosed methods and systems. As shown in FIG. 6, a set of training EMRs 602 is processed by the automated system 604 that assigns medical codes to EMRs to produce a set of code-annotated EMRs 606, as discussed above with reference to FIGS. 2-5. Using illustration conventions similar to those used in FIG. 2, each processed EMR, such as processed EMR 608, is associated with a set of codes, such as codes 610, with high probabilities of being related to the information contained in the EMR. In a next step, the same set of EMRs annotated by human analysts or by some other method 612 are compared, EMR-by-EMR, in order to determine a level of correspondence between the automatically generated medical-code assignments and those produced by human analysts or other means. The results of these comparisons are then, in a third step, used to adjust weights and, in certain cases, one or more of the thresholds used in the automated assignment of individual medical codes to EMRs 614 so that the automated assignment of medical codes to EMRs more closely parallels or matches the assignments made by human analysts or other means.

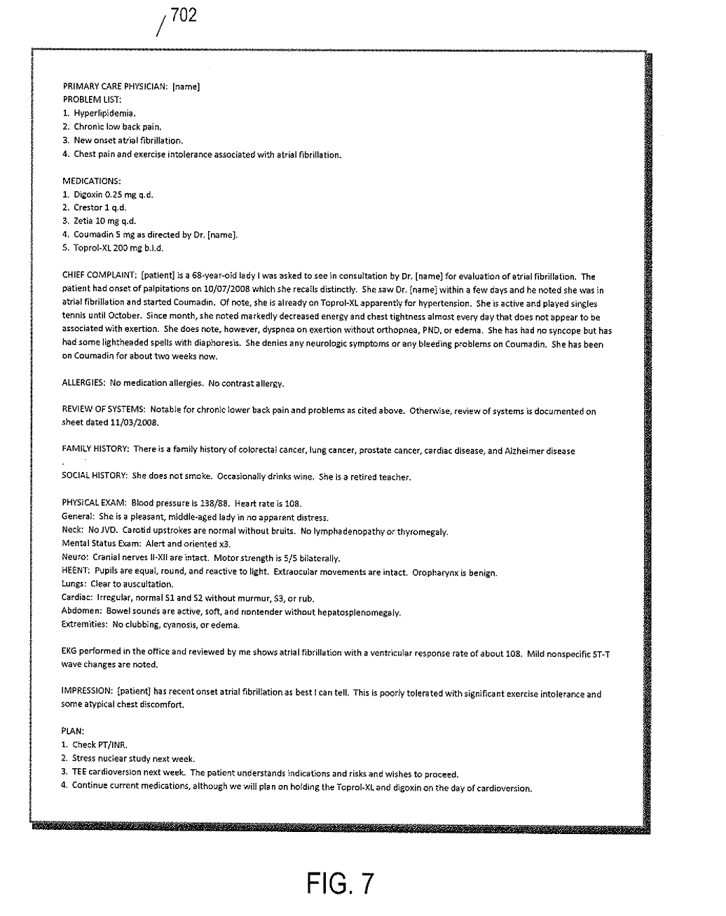

FIG. 7 shows an example of an electronic medical record. The EMR 702 is shown as a text document. An EMR may be stored as an electronic text-based document in any of many standardized and popular electronic document formats, such as those used to store text documents for processing by any of many different popular word-processing applications. An EMR may alternatively be stored within a database, various additional types of files, and in other formats and encodings. The example EMR shown in FIG. 7 is used, in subsequent figures and discussion, to illustrate various aspects of the currently disclosed method and systems for automated assignment of medical codes to EMRs.

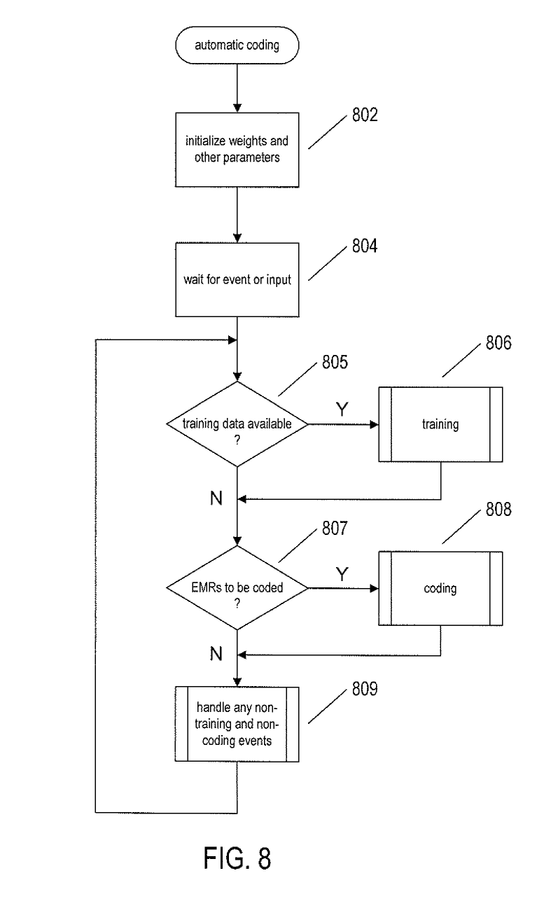

FIGS. 8-10 provide high-level control-flow diagrams that illustrate one implementation of an automated system that assigns medical codes to EMRs. FIG. 8 shows a control-flow diagram for the routine “automatic coding” that represents the highest level of an example implementation of the currently disclosed methods and systems. In step 802, the weights used to compute scores associated either with entire medical codebooks or with subcodes selected from medical codebooks are initialized along with additional parameters, such as various threshold values. In certain cases, the initialization may rely on previously collected data and results of training, may be empirically derived based on various considerations related to the streams generated from EMRs and codes employed in the stream-comparison operation, discussed above with reference to FIG. 3, or may be set to initial, neutral values, such as 0.5 for the weights used to compute scores produced by the stream-comparison operation. Next, in the simple event loop of steps 804-809, the routine “automatic coding” waits for a next event or input and then handles the event or input. When the event or input is the availability of training data, as determined in step 805, then the routine “training” is called in step 806 to carry out the training and feedback discussed above with reference to FIG. 6. When the event is the availability of one or more EMRs to automatically assign codes to, as determined in step 807, then, in step 808, the routine “coding” is called to carry out automated assignment of codes to the EMRs, as discussed above with reference to FIG. 2. Other types of events or inputs are handled in step 809. These may include administrative inputs and requests, requests to terminate automatic coding, requests for storage, recovery, or transmission of EMRs with assigned codes, and many other types of events and inputs. The current discussion focuses on the events that lead to invocation of the routines “training” 806 and “coding” 808.

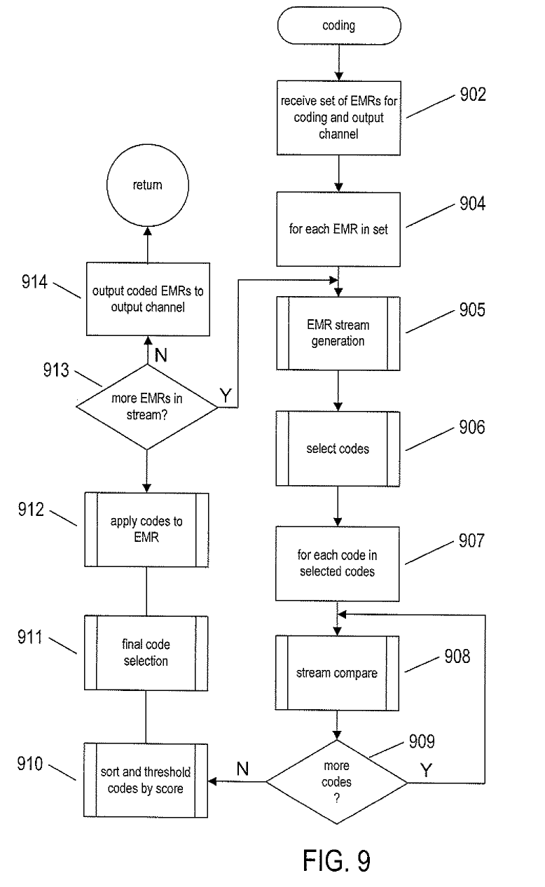

FIG. 9 provides a control-flow diagram that illustrates the routine “coding,” called in step 808 of FIG. 8. In step 902, the routine “coding” receives a set of EMRs for coding as well as an indication of an output channel to which the coded EMRs are to be output. In the nested for-loops of steps 904-913, the routine “coding” carries out a stream-comparison operation for each EMR of the set with respect to each code in a medical codebook or medical-codebook subset. In certain implementations, an EMR may be initially evaluated to select a subset of codes within each of one or more medical codebooks from which individual medical codes are selected for evaluation, in order to more efficiently process EMRs. In step 905, the routine “coding” calls the routine “EMR stream generation” to generate multiple term or term-and-phrase streams from the EMR that is currently considered in the outer for-loop of steps 904-906 and 910-913. In step 906, an asynchronous routine “select codes” is called to initiate generation of term or term-and-phrase streams for codes selected from a medical codebook or medical-codebook subset. In the inner for-loop of steps 907-909, the routine “coding” carries out the stream-comparison operation, represented by the routine “stream compare” in step 908, for each code in the medical codebook or medical-codebook subset. As a result of execution of the inner for-loop of steps 907-909, a set of codes and associated scores, as discussed above with reference to FIG. 5, is generated. In step 910, the routine “coding” calls a routine to sort and threshold the set of codes and associated scores, as also discussed above with reference to FIG. 5. In step 911, the routine “coding” calls a routine “final code selection” to use a thresholding method, or other method, to select the codes that are most probably related to information contained in the currently considered EMR, as also discussed above with reference to FIG. 5. Then, in step 912, the routine “coding” calls a routine “apply codes to EMR,” in step 912, to generate a code-annotated EMR corresponding to the currently considered EMR, as discussed above with reference to FIG. 2. The outer loop of steps 904-906 and 910-913 continues until the input EMRs have been annotated with codes. In step 914, the code-annotated EMRs corresponding to the input EMRs are output to the output channel. The output channel may indicate that the code-annotated EMRs are to be stored internally within the system, stored in an external data-storage device or system, entered into a database, either internal or external to the automated-coding system, or transmitted to a remote system, or another type of output operation.

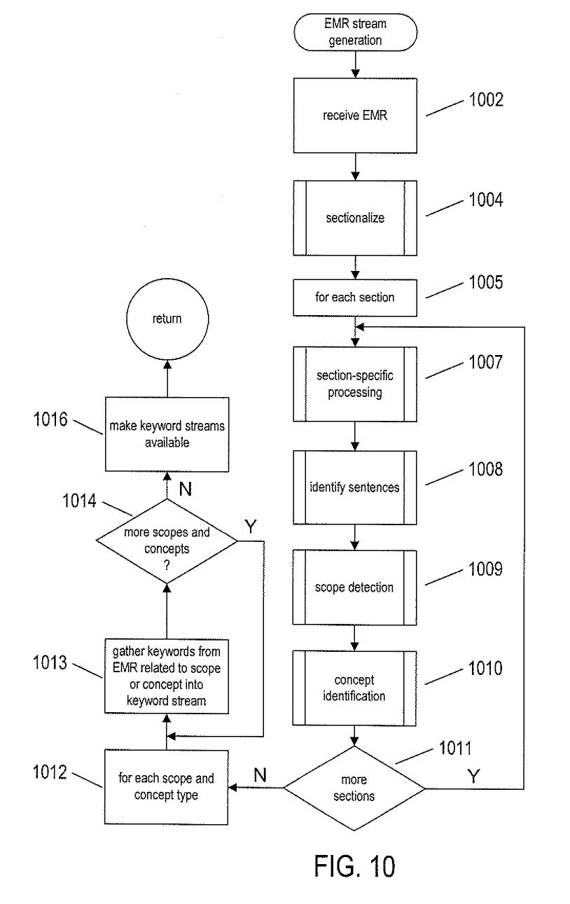

FIG. 10 provides a control-flow diagram that illustrates the routine “EMR stream generation” called in step 905 of FIG. 9. In step 1002, the routine “EMR stream generation” receives an EMR, namely the currently considered EMR in the outer for-loop of FIG. 9. In step 1004, the routine “sectionalize” is called in order to identify sections within the EMR. In the for-loop of steps 1006-1011, each identified section is processed. In step 1007, the currently considered section is processed to add section-specific attributes or parameters to the section to facilitate further processing. For example, a section header may indicate that the section indicates conditions not present in a patient, as a result of which the section may be associated with an attribute to indicate that terms and phrases within the section may be directed to a negation stream, as discussed further below. In step 1008, sentences are identified within the section. In step 1009, scope detection, further discussed below, is carried out within the section to identify terms or terms and phrases within the section to be included within particular streams of terms or terms and phrases generated from the currently considered EMR. In step 1010, concepts within the section are identified. Next, in the for-loop of steps 1012-1014, medical keywords related to each identified scope and concept type in the for-loop of steps 1005-1011 are gathered and input into a term or term-and-phrase stream that is generated from the currently considered EMR, as discussed above with reference to FIG. 3. The multiple term or term-and-phrase streams generated in the for-loop of steps 1012-1014 are then made available, in step 1016, to the stream-comparison operation represented by step 908 in FIG. 9.

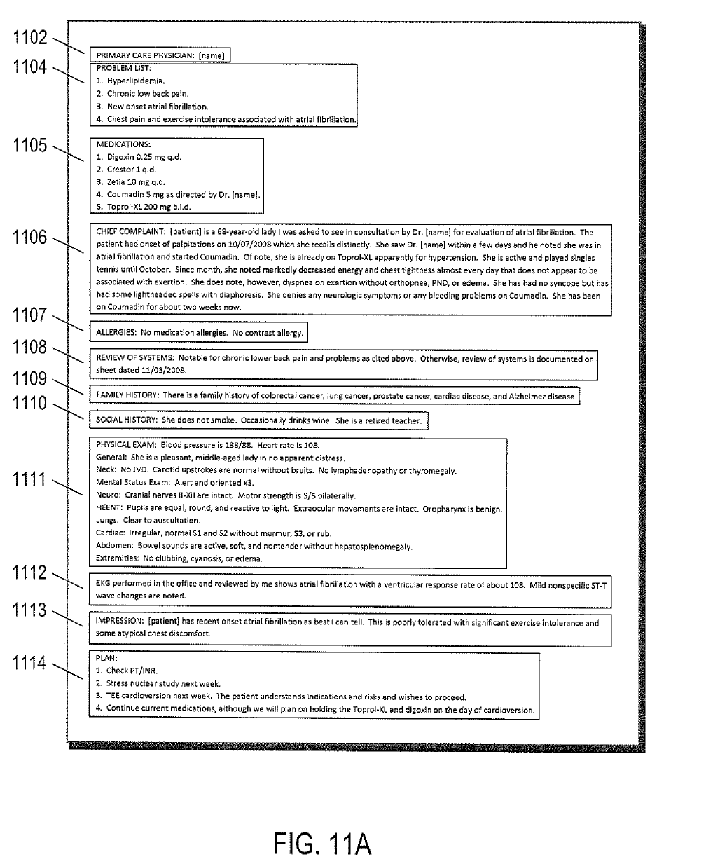

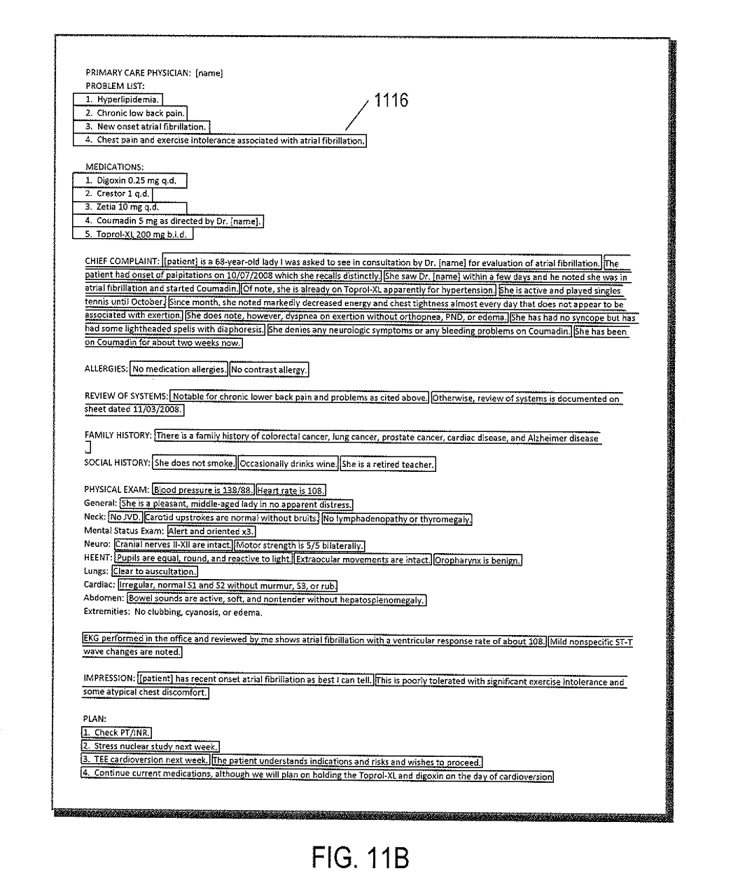

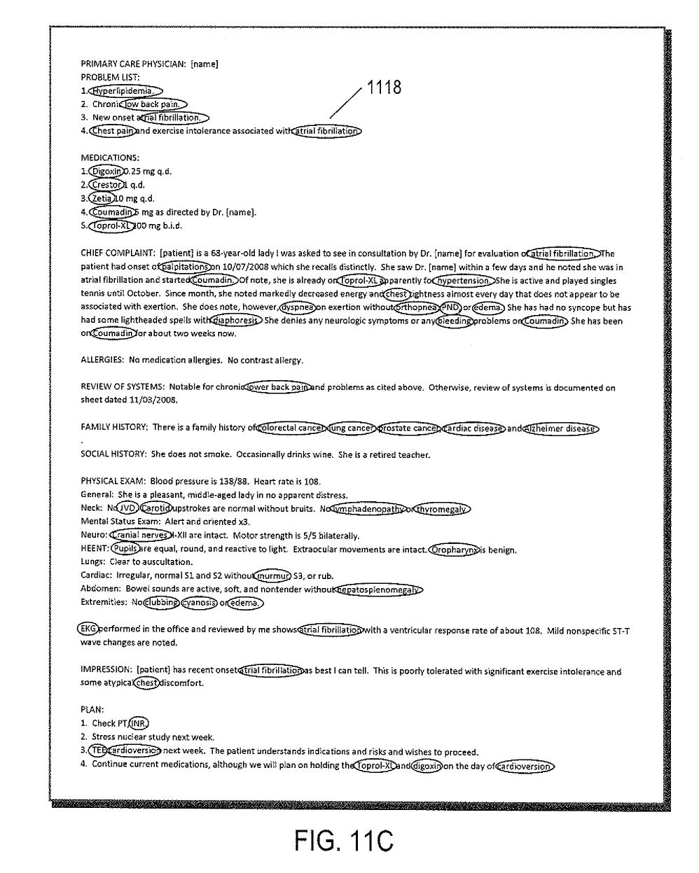

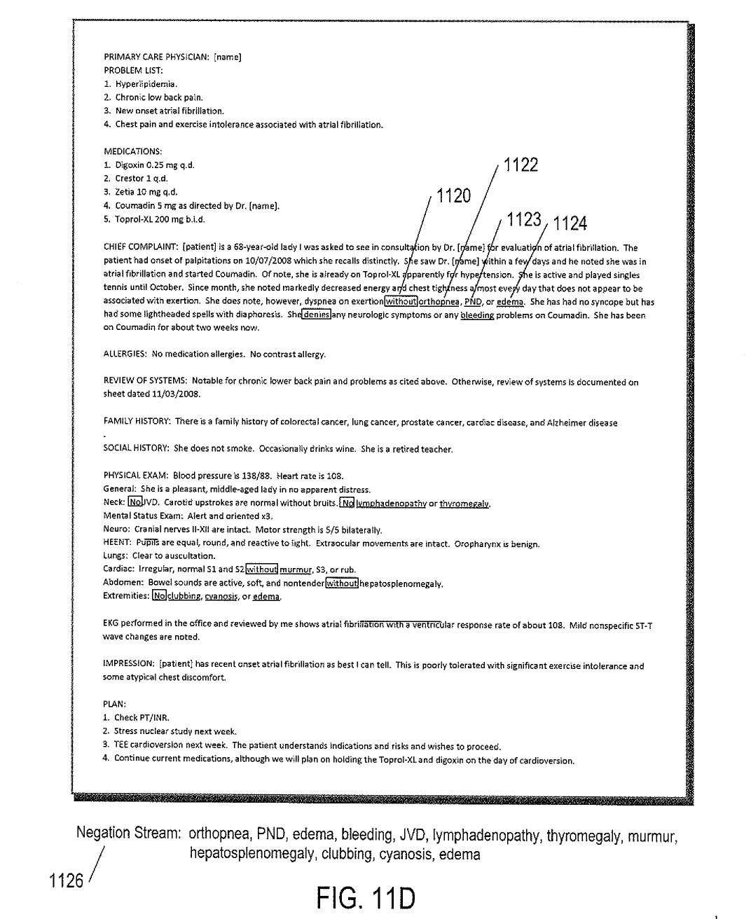

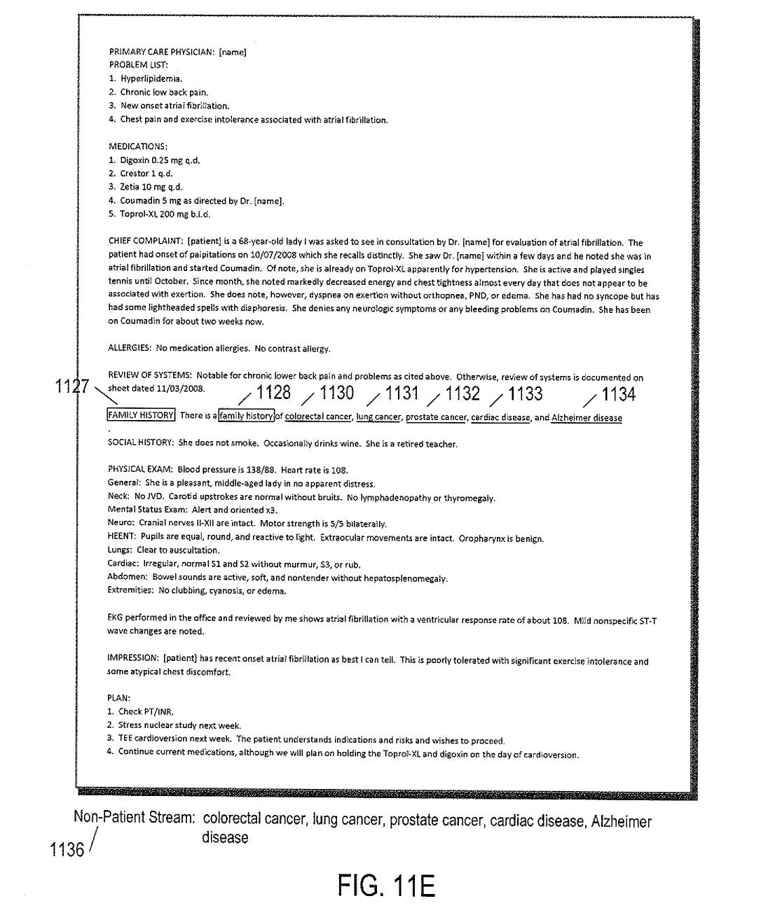

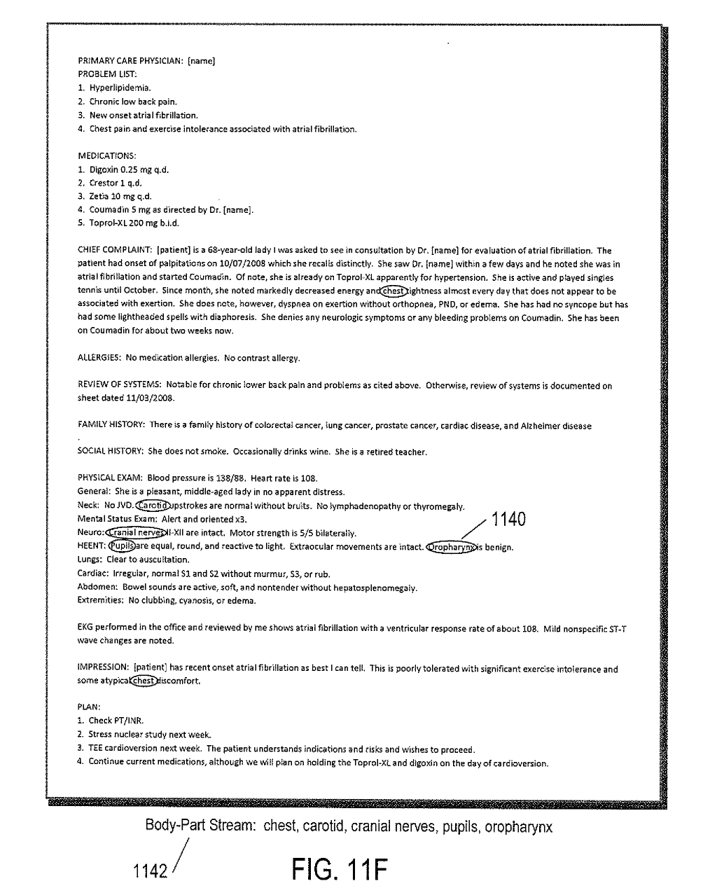

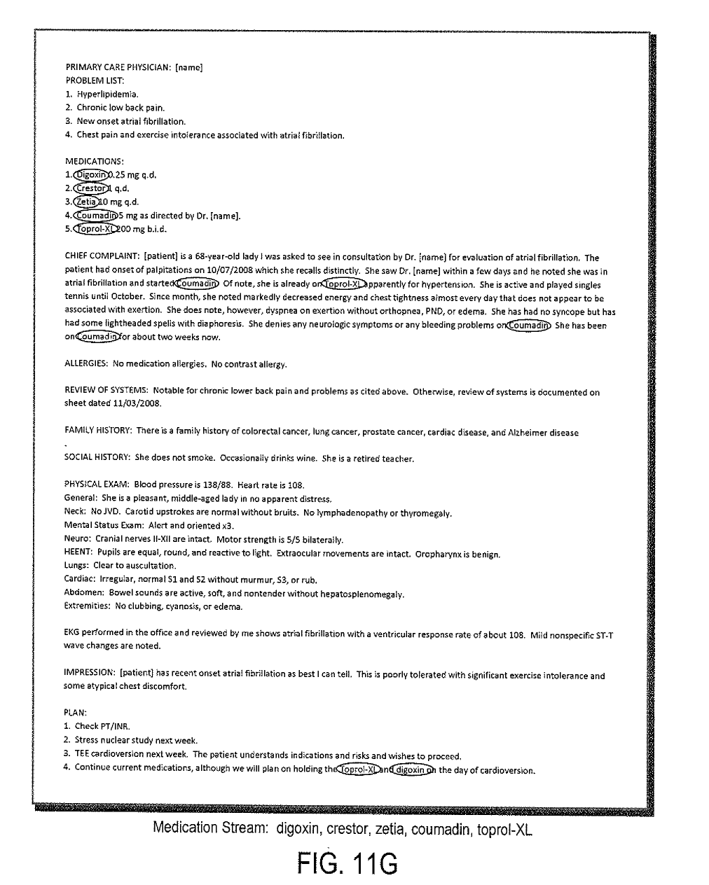

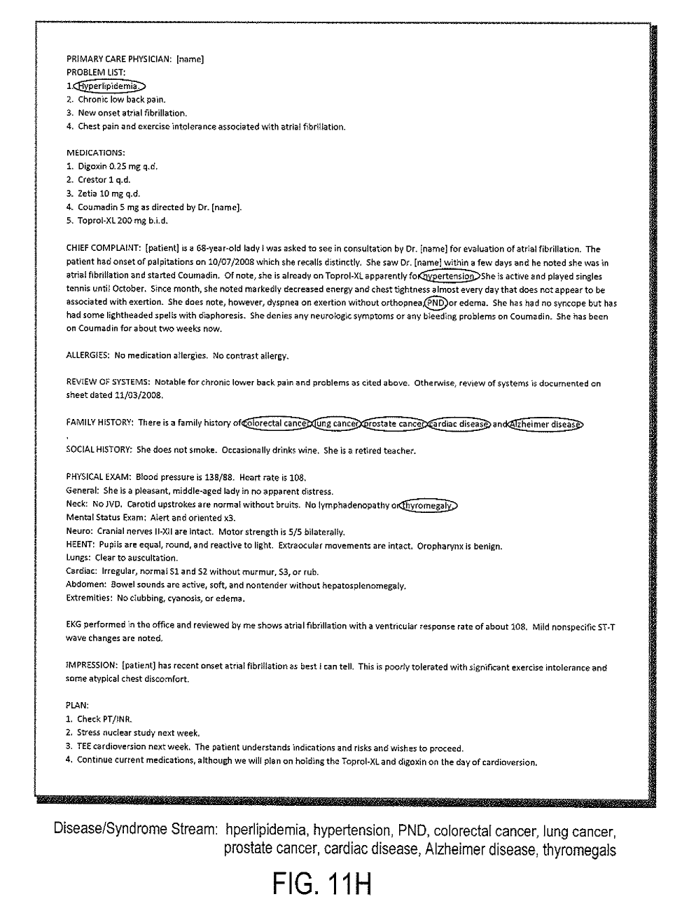

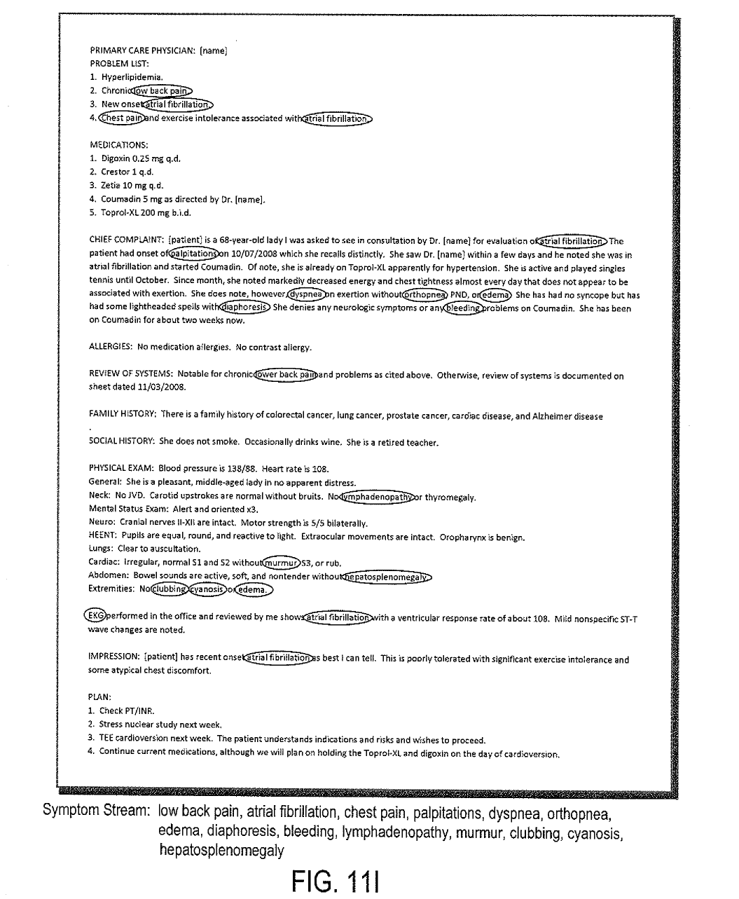

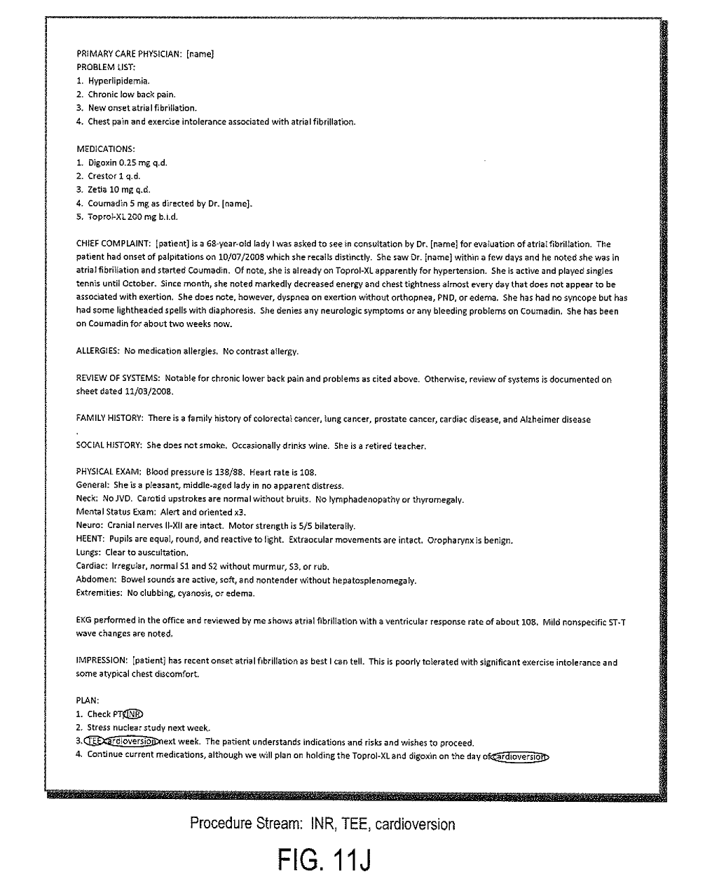

Rather than provide control-flow diagrams that describe the various operations carried out in the for-loop of steps 1005-1011 in FIG. 10, these operations are illustrated with respect to the example EMR shown in FIG. 7. FIGS. 11A-J illustrate generation of a number of example term or term-and-phrase streams from the example EMR shown in FIG. 7. It should be noted, at the onset, that these are example term or term-and-phrase streams and that many additional and alternative types of term or term-and-phrase streams may be generated in various different implementations. Furthermore, these streams may comprise individual terms, comma-separated terms and phrases, or other such types of information in different implementations.

FIG. 11A illustrates sectionalization of the example EMR, as carried out in step 1004 of FIG. 10. As shown in FIG. 11A, the example EMR can be divided into 12 different sections 1102-1114. The detailed implementation of the sectionalization functionality, of course, depends on the format of content of the EMRs processed by the automated system. In an example EMR, sections are introduced by a section title followed by a colon, with the section title all in upper case. Thus, the sections can be identified straightforwardly by finding these section titles and including them with following information prior to the next section title.

FIG. 11B illustrates the identification of sentences within the example EMR, carried out in step 1008 of FIG. 10. In FIG. 11B, each identified sentence is enclosed within a rectangle, such as rectangle 1116. Sentences may be traditional English-language sentences that begin with a capitalized letter and end with a period, but also may contain various separable phrases that constitute incomplete sentences.

FIG. 11C illustrates identification of medical terms and phrases within the EMR. In certain implementations, only medical terms and phrases are returned in the various term or term-and-phrase streams generated from the EMR for use by the stream-comparison operation. In FIG. 11C, those terms and phrases identified as being medical terms and phrases are encircled with ellipses, such as ellipse 1118. Medical terms and phrases can be found in any of many different types of electronic references, or sources of medical terms and phrases, including online medical dictionaries, texts, and compiled lists of medical terms and phrases stored on one or more data-storage devices.

FIGS. 11D and 11E illustrate two examples of scope detection, carried out in step 1009 of FIG. 10. In a first type of scope detection, illustrated in FIG. 11D, words that introduce negated terms and phrases are identified and the negated terms and phrases associated with these identified negative terms and phrases are then extracted and added to a negation stream. In FIG. 11D, the words that introduce negated terms and phrases are enclosed within rectangles, such as rectangle 1120. The medical terms and phrases that are negated by these terms and phrases are underlined, such as the underlined terms 1122-1124. The negated terms and phrases are then added to a negation stream 1126 as shown below the example EMR in FIG. 11D. In various implementations, additional processing of the terms or terms and phrases added to the negation stream may occur. For example, acronyms may be expanded and the various grammatical forms of an individual terms or terms within phrase may be normalized and canonicalized. This type of processing may accompany generation of any of the other streams generated from an EMR, examples of which are discussed below. FIG. 11E illustrates extraction of terms and phrases for a non-patient stream based on identifying terms and phrases that identify or render following or preceding terms and phrases likely non-patient terms and phrases. In FIG. 11E. the section title 1127 and phrase 1128 “family history” renders the following underlined medical terms and phrases 1130-1134 to be likely non-patient terms and phrases. Thus, these underlined terms and phrases are added to the non-patient stream 1136.

Note that, in certain implementations, streams contain only terms, with recognized medical phrases broken into individual terms during addition to the streams. In other implementations, both terms and phrases are added to streams and separated by commas. Many other types of streams are possible. It should also be noted that, while there is an element of natural-language processing in the generation of streams, such as recognizing words that render preceding or following terms to be negated or that render preceding or following terms to be likely associated with individuals other than patients, as in the examples of FIGS. 11D-E, this natural-language processing need not be completely accurate and reliable in order to produce precise and reliable automated medical-code annotation of EMRs. Because of the presence of learned weights and because of the cross-product-like comparison of many different possible stream pairs, the stream-comparison operation and other features of the currently disclosed methods and systems can tolerate significant levels of noise and incorrect identification of syntactical and semantic elements within an EMR and still produce precise, accurate, and reliable medical-code annotation.

FIG. 11F illustrates generation of a body-part stream containing terms and phrases related to body parts. The various terms and phrases, shown in FIG. 11C, identified to be medical terms and phrases can be subdivided into various types or categories, such as medical terms and phrases related to body parts, medications, diseases and syndromes, symptoms, and medical procedures. Those identified medical terms and phrases related to body parts, shown within ellipses, such as ellipse 1140 in FIG. 11F, are collected into a body-part stream 1142. Similarly, as shown in FIGS. 11G-J, a medication stream, a disease/syndrome stream, a symptom stream, and a procedure stream may be generated by including in those streams the identified medical terms and phrases related to medications, diseases/syndromes, symptoms, and procedures.

The streams generated from an EMR are therefore sets of medical terms or medical terms and phrases. They are referred to as streams because they are stored and processed in a way that allows successive terms and phrases to be extracted from the streams during the stream-comparison operation. There are many possible implementations of term or term-and-phrase streams commonly employed in a variety of different types of computational systems and applications.

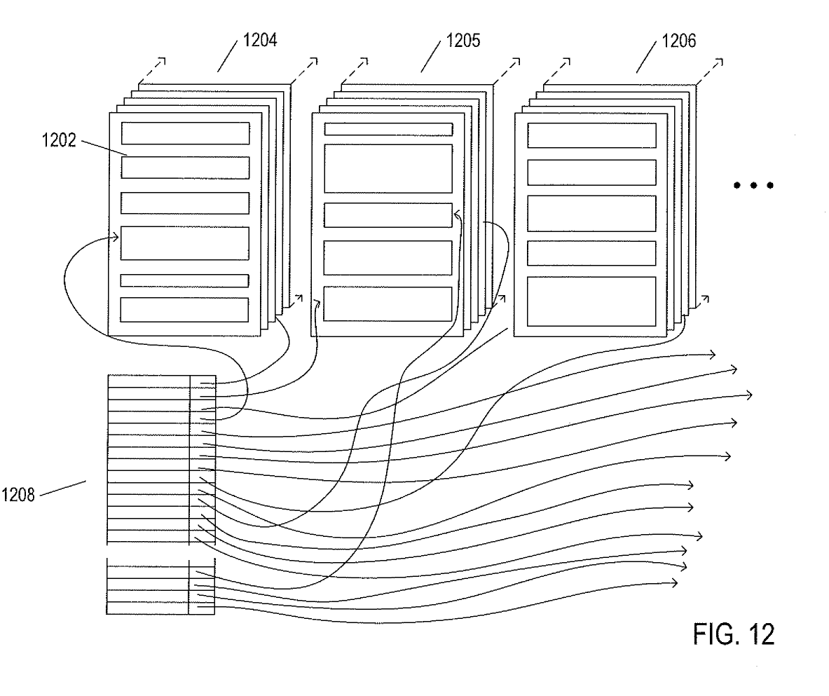

FIG. 12 illustrates organization of a typical medical codebook. The medical codebook comprises a large set of individual medical codes described by entries, such as entry 1202. In general, the entries are sequentially as well as hierarchically organized. As shown in FIG. 12, the medical codebook is partitioned into chapters 1204-1206 and may be further partitioned, hierarchically, within chapters into sections, subsections, and other levels of organization. In addition, the medical codebook may have an index 1208 that lists medical terms or terms and phrases along with references to individual medical codes, or entries, in the medical codebook related to the medical terms or terms and phrases.

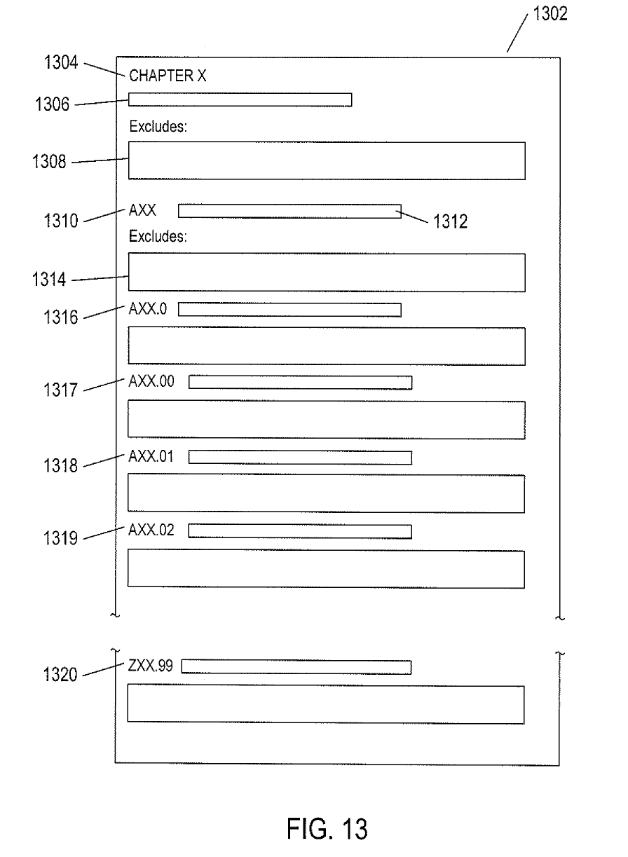

FIG. 13 illustrates one type of hierarchical organization within a medical codebook. FIG. 13 shows a portion of a chapter 1302 of a medical codebook, the chapter including a chapter heading 1304 along with a chapter title and/or description 1306. The chapter may include an “excludes” section 1308 that lists various types of medical terminology and concepts to which entries within the chapter are generally not related. The chapter next contains individual-code entries. In many cases, the individual codes are hierarchically organized. For example, a first code 1310 within the chapter is represented by an alphanumeric code and includes a description and/or title 1312. The entry for this code also includes an “excludes” section 1314 and may include any of many additional sections. Following the initial code 1310 are entries for hierarchically related codes 1316-1319. These related codes represent a first hierarchical level of subcodes underneath the initial code 1310. A medical codebook may include an arbitrary number of levels of hierarchical codes below each first-level code. A medical-code chapter may include hundreds, thousands, tens of thousands or more individual-code entries. The final first-level code 1320 is shown at the end of the representation of the chapter 1302 in FIG. 13.

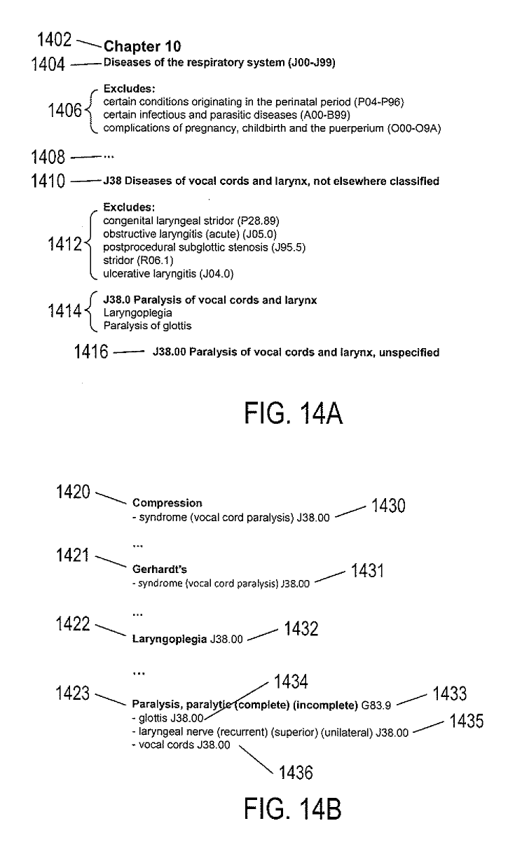

FIGS. 14A-B show small portions of an actual medical codebook. FIG. 14A shows the beginning of a chapter within the medical codebook. This portion of the medical codebook includes a chapter header 1402 and chapter title/summary 1404. Next, there is an “excludes” section for the chapter 1406. There may be additional sections and information pertaining to the chapter, as represented by ellipses 1408. This chapter includes the top-level codes J00 through J99. The entry for the code J38 begins with the code and a title/summary 1410 followed by an “excludes” section 1412. Following the entry for code J38, an entry for the first, next-lower-level code, J38.0, is shown 1414 followed by an entry for a next lower-level code J38.00 1416. FIG. 14B shows a small portion of an index for the medical codebook illustrated in FIGS. 14A-B. In FIG. 14B, a number of medical-term entries 1420-1423 are shown along with associated references 1430-1436 to the individual medical code J38.00 represented by entry 1416 in FIG. 14A.

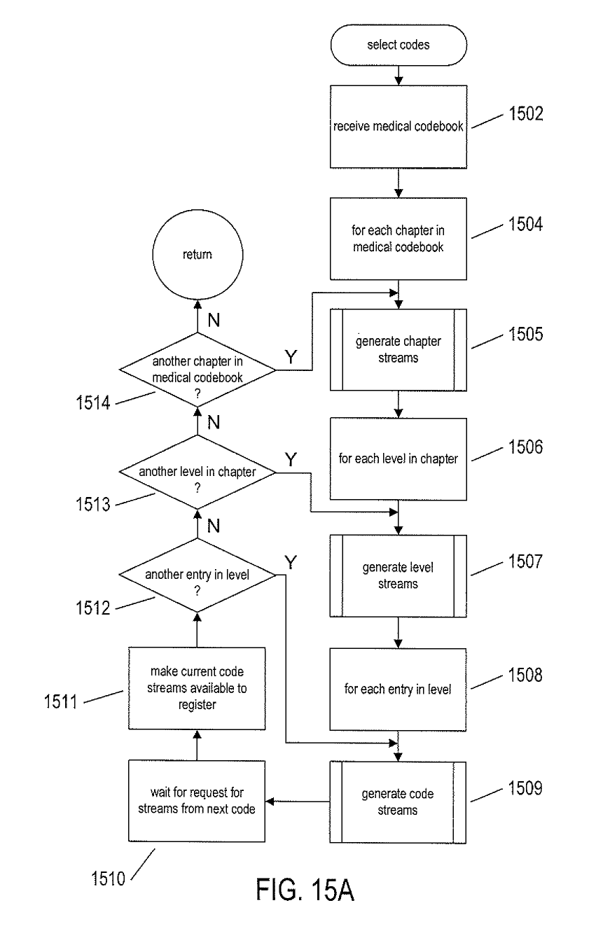

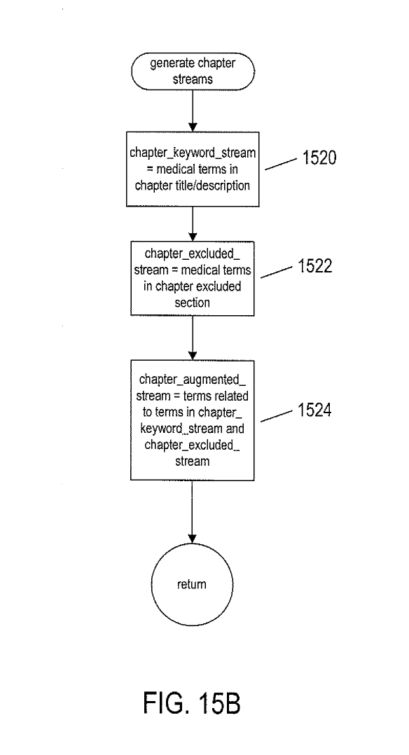

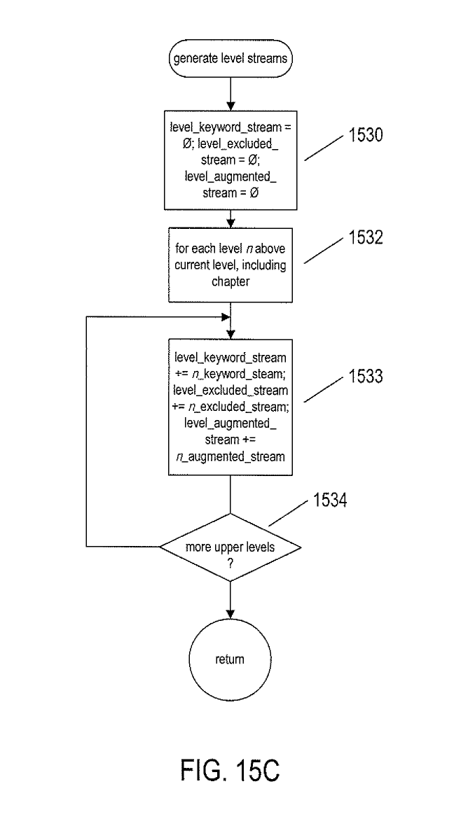

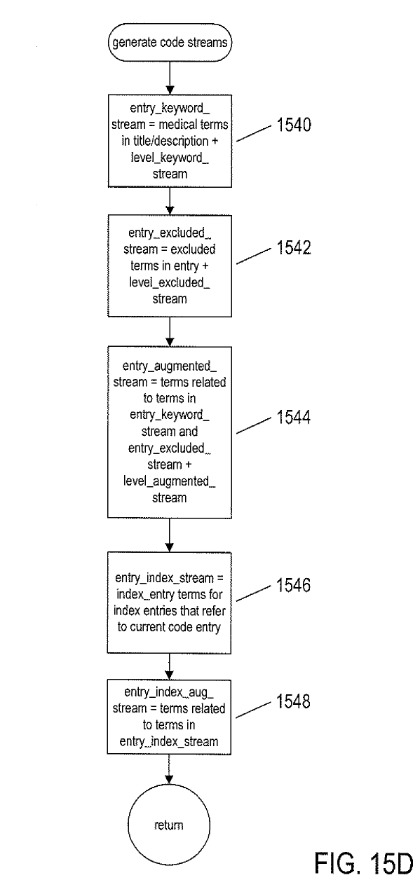

FIGS. 15A-D provide control-flow diagrams that complete the description of one implementation of an automated medical-code assignment system that includes references to FIGS. 8-10. FIG. 15A provides a control-flow diagram for the routine “select codes” called in step 906 of FIG. 9. In step 1502, the routine “select codes” receives a medical codebook. In the nested for-loops of steps 1504-1514, the routine “select codes” considers each chapter in the medical codebook, each code level within each chapter, and each code entry within each code level. For the currently considered chapter, the routine calls a routine “generate chapter streams,” in step 1505. For each code level within the chapter, the routine calls the routine “generate level streams” in step 1507. For each individual medical code entry within each code level, the routine calls the routine “generate code streams” in step 1509. The calls to the routines “generate chapter streams,” “generate level streams,” and “generate code streams” prepare partial streams for all hierarchical levels above a code that is currently considered within the outer for-loop of steps 904-906 and 910-913 in FIG. 9. In step 1510, the routine “select codes” waits for a request for a set of term or term-and-phrase streams generated from a next considered code. That request is made by the stream-comparison operation in step 908 of FIG. 9. When a next request is received, streams for a next code are made available to the stream-comparison operation in step 1511.

FIG. 15B provides a control-flow diagram that illustrates the routine “generate chapter streams,” called in step 1505 of FIG. 15A. A chapter_keyword_stream is created to include those medical terms or medical terms and phrases found in the chapter title and chapter description for the chapter within a medical codebook in step 1520. In step 1522, a chapter_excluded_stream is created to include medical terms or medical terms and phrases extracted from the excluded section of the chapter. In step 1524, a chapter_augmented_stream is created to include terms or terms and phrases related to the terms or terms and phrases in the chapter_keyword_stream and chapter_excluded_stream as determined by reference to any of various different types of electronic sources for related medical terms and phrases.

FIG. 15C provides a control-flow diagram for the routine “generate level streams” called in step 1507 of FIG. 15A. In step 1530, a level_keyword_stream, level_excluded_stream, and level_augmented_stream are all set to the null set. Then, in the for-loop of steps 1532-1534, these three streams are populated with terms or terms and phrases from keyword streams, excluded streams, and augmented streams of all of the hierarchically related entries in levels above the level of a currently considered entry.

FIG. 15D provides a control-flow diagram for the routine “generate code streams” called in step 1509 of FIG. 15A. This routine generates the term or term-and-phrase streams for a particular individual medical code within a medical codebook. In step 1540, a keyword stream for the entry is created to include those medical terms or medical terms and phrases within the title and description of the medical codebook corresponding to the entry as well as all the terms or terms and phrases included in the keyword stream for all related higher-level entries within the medical codebook. In step 1542, the routine “generate code streams” creates an excluded stream that includes all the medical terms or medical terms and phrases in the excluded section for an individual medical code within the medical codebook along with excluded terms in higher-level, related entries. Similarly, in step 1544, an augmented stream is created for the code entry to include terms related to the terms already included in the keyword stream and excluded stream and also terms or terms and phrases in the augmented streams of all higher-level related entries. In step 1546, the routine “generate code streams” creates an index stream for the entry that includes medical terms or medical terms and phrases found in the index of the medical codebook that include references to the current code entry. Finally, in step 1548, medical terms or medical terms and phrases related to the terms or terms and phrases in the index stream, found in various sources for related terms, such as electronic medical dictionaries, are included in an index augmentation stream for the currently considered code.

As discussed above, any particular implementation may use any of many different types of term or term-and-phrase streams generated from EMRs and from individual medical code entries within a medical codebook as a basis for conducting the stream-comparison operation discussed above with reference to FIG. 3. The stream-comparison operation uses these streams in order to compute a score, the magnitude of which is related to the probability that a particular individual medical code within a medical codebook is related to the information contained within a particular EMR.

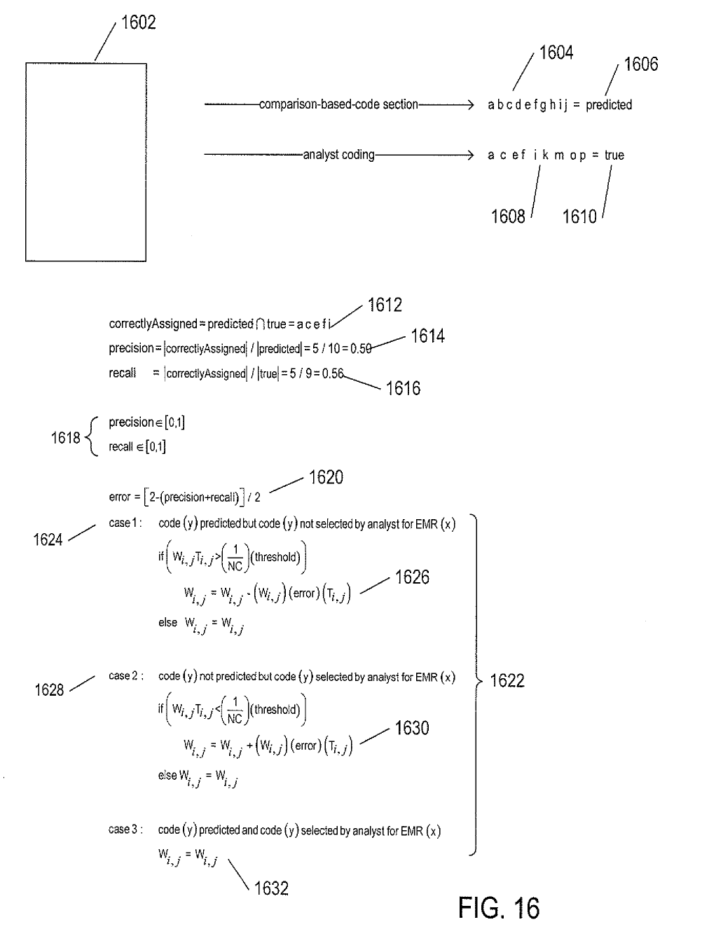

FIG. 16 illustrates aspects of the training compare operation, discussed above with reference to FIG. 6, in which medical codes associated with an EMR by an automated system are compared to the medical codes associated with the same EMR by human analysts or by another method. At the top of FIG. 16, an EMR 1602 is subject to automated medical-code association to produce a set of individual medical codes 1604 referred to as the set “predicted” 1606. In FIG. 16, individual medical codes are represented by lower-case letters. Thus, for EMR 1602, the ten different individual medical codes represented by lower-case letters “a,” “b,” “c,” “d” “e,” “f,” “g,” “h,” “i,” and “j” have been automatically associated with the EMR and included in the set predicted. The same EMR has been analyzed by human analysts, who have assigned nine different individual medical codes 1608 to the EMR which are together considered to comprise the set “true” 1610. In other words, the set “predicted” contains codes associated with the EMR by the automated medical-coding system and the set “true” includes the codes associated with the EMR by human analysts or by some other means.

A derived set and two different real-number values are next computed from the sets “predicted” and “true.” A set “correctlyAssigned” is constructed as the intersection of the elements of the sets “predicted” and “true” 1612. In the example shown in FIG. 16, the set “correctlyAssigned” includes five codes: “a,” “c,” “e,” “f,” and “i.” The value “precision” is computed as the ratio of the cardinality of the set “correctlyAssigned” to the cardinality of the set “predicted” 1614. In the current example, the value “precision” has the numeric value 0.5. Similarly, a real value “recall” is computed as a cardinality of the set “correctlyAssigned” divided by the cardinality of the set “true” 1616. In the current example, the numeric value of the value “recall” is 0.56. As indicated 1618 in FIG. 16, the values “precision” and “recall” fall within the range [0,1]. When the sets “predicted” and “true” contain the same codes, both the precision and recall have value 1.0. When the sets “predicted” and “true” contain no common codes, the values “precision” and “recall” are both 0.0.

One measure of the error in automated code assignment is:

error=[2−(precision+recall)]/2,

as shown 1620 in FIG. 16. This error value can be used in order to adjust the weights used to compute scores during training of an automated system that assigns medical codes to EMRs. Weight adjustment is expressed by the pseudocode 1622 shown in FIG. 16. When a particular code, code(y), is associated by the automated system with an EMR but was not associated by human analysts with the EMR, representing case 1 1624, then any weights W_{i,j} within terms W_{i,j}T_{i,j} in the computation of the score for the EMR and code that contributed significantly to the score are adjusted downward 1626 by an amount proportional to the computed error and the magnitude of the term. Similarly, when a particular code, code(y), was not associated with EMR by the automated system but was associated with the EMR by human analysts, representing case 1628, then all of the weights within terms W_{i,j}T_{i,j} that did not significantly contribute to the magnitude of the score computed for the EMR in code are adjusted upward 1630. When the code, code(y), is both predicted by the automated system and selected by human analysts, then no adjustment to the weights is made 1632. This represents just one of many different possible weight-adjustment schemes. In addition, the threshold used for selecting related codes, discussed above with reference to FIG. 5, can be adjusted upward or downward to decrease or increase the number of codes typically associated by an automated medical-coding system to an EMR.

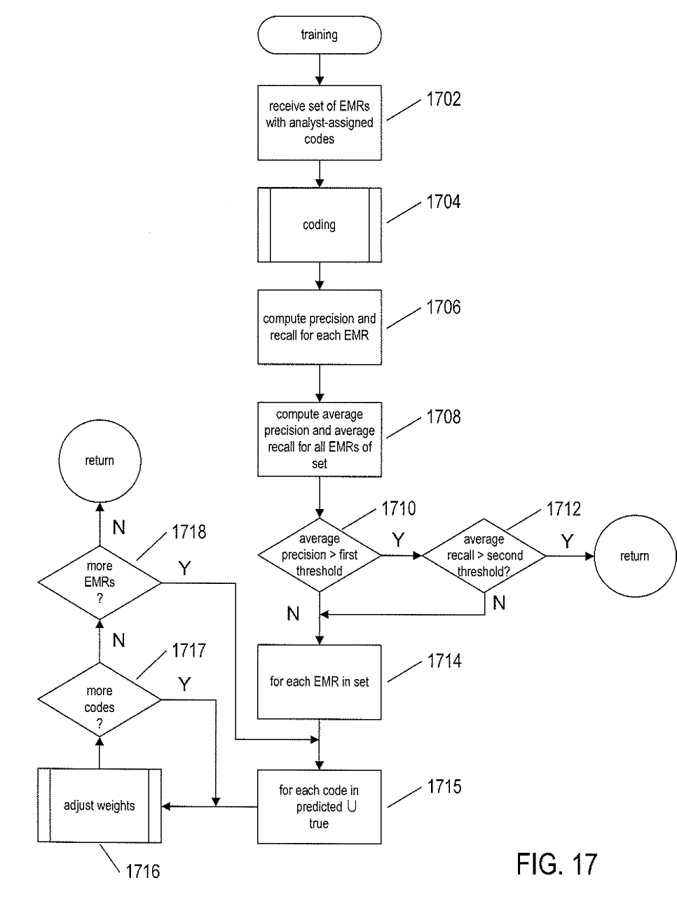

FIG. 17 provides a control-flow diagram for the routine “training,” called in step 806 of FIG. 8. In step 1702, the routine “training” receives a set of EMRs with analyst-assigned codes. In step 1704, the routine “training” invokes the routine “coding” to automatically assign codes to each of the EMRs in the received set of EMRs. In step 1706, the routine “training” computes the precision and recall for each of the EMRs, as discussed above with reference to FIG. 16. In step 1708, the routine “training” computes an average precision and average recall for all of the EMRs in the set of received EMRs. When, as determined in step 1710, the average precision is greater than a first threshold and, as determined in step 1712, the average recall is greater than the second threshold, the routine “training” returns, since automated medical-code assignment is currently being carried out with sufficient precision and accuracy, as encoded in the first and second thresholds. Otherwise, in the for-loop of step 1714-1718, the weights used for computing scores are adjusted according to the weight-adjustment procedure discussed above with reference to FIG. 16 or other such weight-adjustment schemes. Weight-adjustment schemes can be based on any of various different optimization procedures, such as Newton's dissent and gradient-based procedures, and by many other types of procedures that seek to train a system for accurate and precise prediction.

Although the present invention has been described in terms of particular embodiments, it is not intended that the invention be limited to these embodiments. Modifications within the spirit of the invention will be apparent to those skilled in the art. For example, any of a variety of different implementations of an automated medical-code-assignment system can be obtained by varying any of many different design and development parameters, including programming language, underlying operating system, modular organization, control structures, data structures, and other such design and development parameters. A variety of different specific implementations of the stream-comparison operation and comparison operations used for training are possible. In alternative implementations, an automated medical-coding system may assign sets of codes extracted from two or more different medical codes to each EMR.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated medical-coding system comprising:
one or more processors;
one or more memories; and
computer instructions stored in one or more data-storage components of the automated medical-coding system that, when transferred to one or the one or more memories and executed by one or the one or more professors, control the automated medical-coding system to
receive an electronic medical record,
generate multiple term streams from the electronic medical record,
for each of multiple individual medical codes of a medical codebook,
generate multiple term streams for the individual medical code,
compute a score for each of the multiple individual medical codes based on comparing the term streams generated from the electronic medical record and the term streams generated for the individual medical code,
select individual medical codes based on the computed scores,
annotate the electronic medical record with the selected individual medical codes, and
store the annotated electronic medical record in one of the one or more memories.

2. The automated medical-coding system of claim 1 wherein each term stream is one of:
a set of electronically stored terms that can be accessed term-by-term as a stream of terms; and
a set of electronically stored entities, each entity a term or a phrase, that can be accessed entity-by-entity as a stream of entities.

3. The automated medical-coding system of claim 2 wherein the automated medical-coding system generates multiple term streams from the electronic medical record by:
identifying sections within the electronic medical record;
for each identified section,
assigning section-specific attributes to the identified section,
identifying sentences within the identified section, and
identifying medical terms within the identified sections associated with scopes and concepts; and
creating a term stream for each of the scopes and concepts that includes identified medical terms contained in the identified sections related to the scope or concept for which the term stream is created.

4. The automated medical-coding system of claim 3 wherein the concepts and scopes include:
a negation scope;
a non-patient scope;
a body-part concept;
a medication concept;
a disease/syndrome concept;
a symptom concept; and
a procedure concept.

5. The automated medical-coding system of claim 2 wherein the automated medical-coding system generates multiple term streams for an individual medical code by:
for each chapter of a corresponding medical codebook,
generating multiple chapter term, streams; and
for each code in the chapter,
creating multiple level term streams;
for each higher-level code hierarchically related to the code,
for each of the multiple created level term streams,
adding the contents of a term stream associated with the higher-level code to the created level term stream;
creating multiple term streams for the code;
for each of the multiple created code term streams that corresponds to a created level term stream, adding the contents of the created level term stream to the created code term stream; and
for each of the multiple created code term streams that corresponds to a created chapter term stream, adding the contents of the created chapter term stream to the created code term stream.

6. The automated medical-coding system of claim 5 wherein the multiple term streams for an individual medical code include:
a keyword term stream that includes medical terms contained in a title and description of the individual medical code, any higher-level medical codes hierarchically related to the individual medical code, and the chapter containing the individual medical code;
an excluded term stream that includes medical terms contained in an excluded section of the individual medical code, any higher-level medical codes hierarchically related to the individual medical code, and the chapter containing the individual medical code; and
an augmented term stream that includes medical terms or terms and phrases related to the medical terms or terms and phrases contained in the keyword term stream and the excluded term stream obtained from one or more sources of medical terms and phrases.

7. The automated medical-coding system of claim 6 wherein the multiple term streams for an individual medical code further include:
an index term stream containing medical terms or medical terms and phrases related to the individual medical code in one or more indexes of the medical codebook; and
an augmented index term stream containing medical terms or terms and phrases related to the medical terms or terms and phrases contained in the index term stream obtained from one or more sources of medical terms and phrases.

8. The automated medical-coding system of claim 2 wherein the score is computed as a sum of weighted terms, one weighted term for each pair of term streams that includes a term stream selected from the multiple term streams generated from the electronic medical record and a term stream selected from the multiple term streams generated for the individual medical code.

9. The automated medical-coding system of claim 8 wherein each weighted term includes:
a weight factor; and
a term composed of a first factor and a second factor.

10. The automated medical-coding system of claim 9
wherein the first factor is related to a disparity in sizes of the two streams for which the term is computed; and
wherein the second factor is related to a ratio of the cardinality of a set intersection of the two streams for which the term is computed to the cardinality of a set union of the two streams for which the term is computed.

11. The automated medical-coding system of claim 2 wherein the automated medical-coding system selects individual medical codes based on the computed scores by one of:
selecting individual medical codes associated with computed scores that indicate relatedness to the electronic medical record greater than a threshold relatedness; and
selecting individual medical codes associated with computed scores that indicate relatedness to the electronic medical record greater than or equal to a threshold relatedness.

12. The automated medical-coding system of claim 2 further comprising a training mode in which the automated medical-coding system adjusts weights used in computing scores for each of the multiple individual medical codes based on comparing the term streams generated from the electronic medical record and the term streams generated for the individual medical code by:
receiving a set of electronic medical records to each of which a first set of individual medical codes have assigned by human analysts or another method;
assigning a second set of individual medical codes to each of the electronic medical records in the set of electronic medical records by
generating multiple term streams from the electronic medical record,
for each of multiple individual medical codes of a medical codebook,
generating multiple term streams for the individual medical code,
computing a score for each of the multiple individual medical codes based on comparing the term streams generated from the electronic medical record and the term streams generated for the individual medical code,
selecting individual medical codes based on the computed scores;
for each of the electronic medical records in the set of electronic medical records,
comparing the first and second sets of individual medical codes to compute a precision metric and a recall metric,
computing an error based on the precision metric and the recall metric,
adjusting the weights based on the computed error and on the first and second sets of individual medical codes.

13. The automated medical-coding system of claim 12 wherein comparing the first and second sets of individual medical codes to compute a precision metric and a recall metric further includes:
generating a set of accurately predicted individual medical codes as a set intersection of the first and second sets of individual medical codes;
computing the precision as the ratio of the cardinality of the set of accurately predicted individual medical codes to the cardinality of the second set of individual medical codes; and
computing the recall as the ratio of the cardinality of the set of accurately predicted individual medical codes to the cardinality of the first set of individual medical codes.

14. The automated medical-coding system of claim 13 wherein computing an error based on the precision metric and the recall metric further comprises computing the error based on subtracting the precision and the recall from 2.

15. The automated medical-coding system of claim 14 wherein adjusting the weights based on the computed error and on the first and second sets of individual medical codes further comprises:
when an individual medical code is in the first set of individual medical codes but not in the second set of individual medical codes, raising weights of terms greater than a threshold value; and
when an individual medical code is in the second set of individual medical codes but not in the first set of individual medical codes, lowering weights of terms greater than a threshold value.

16. A method that automatically assigns individual medical codes to an electronic medical record within a system that includes one or more processors and one or more memories, the method comprising:
receiving an electronic medical record,
generating multiple term streams from the electronic medical record,
for each of multiple individual medical codes of a medical codebook,
generating multiple term streams for the individual medical code,
computing a score for each of the multiple individual medical codes based on comparing the term streams generated from the electronic medical record and the term streams generated for the individual medical code,
selecting individual medical codes based on the computed scores,
annotating the electronic medical record with the selected individual medical codes, and
storing the annotated electronic medical record in one of the one or more memories.

17. The method of claim 16 wherein each term stream is one of:
a set of electronically stored terms that can be accessed term-by-term as a stream of terms; and
a set of electronically stored entities, each entity a term or a phrase, that can be accessed entity-by-entity as a stream of entities.

18. The method of claim 17 wherein generating multiple term streams from the electronic medical record further includes:
identifying sections within the electronic medical record;
for each identified section,
assigning section-specific attributes to the identified section,
identifying sentences within the identified section, and
identifying medical terms within the identified sections associated with scopes and concepts; and
creating a term stream for each of the scopes and concepts that includes identified medical terms contained in the identified sections related to the scope or concept for which the term stream is created.

19. The method of claim 17 wherein generating multiple term streams for an individual medical code further comprises:
for each chapter of a corresponding medical codebook,
generating multiple chapter term streams; and
for each code in the chapter,
creating multiple level term streams;
for each higher-level code hierarchically related to the code,
for each of the multiple created level term streams,
adding the contents of a term stream associated with the higher-level code to the created level term stream;
creating multiple term streams for the code;
for each of the multiple created code term streams that corresponds to a created level term stream, adding the contents of the created level term stream to the created code term stream; and
for each of the multiple created code term streams that corresponds to a created chapter term stream, adding the contents of the created chapter term stream to the created code term stream

20. The method of claim 17 wherein the score is computed as a sum of weighted terms, one weighted term for each pair of term streams that includes a term stream selected from the multiple term streams generated from the electronic medical record and a term stream selected from the multiple term streams generated for the individual medical code.
